(19) United States
(12) Patent Application Publication
(10) Pub. No.: US 2008/0065834 A1
(43) Pub. Date: Mar. 13, 2008

(54) Method to Prevent Operand Data with No Locality from Polluting the Data Cache

(75) Inventors: Mark A. Check, Hopewell Junction, NY (US); Jennifer A. Navarro, Poughkeepsie, NY (US); Charles F. Webb, Wappingers Falls, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/531,288

(22) Filed: Sep. 13, 2006

(51) Int. Cl. G06F 12/00

(52) U.S. Cl. 711/136

(57) ABSTRACT

A computer system with the means to identify based on the instruction being decoded that the operand data that this instruction will access by its nature will not have locality of access and should be installed in the cache in such a way that each successive line brought into the data cache that hits the same congruence class should be placed in the same set as to not disturb the locality of the data that resided in the cache prior to the execution of the instruction that accessed the data that will not have locality of access.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method to stop the pollution of a local data cache by data that will not have locality, and particularly to when operand data that is in common interchange formats are translated into a format that a given computer system can operate on it natively.

2. Description of Background

Before our invention when data that was in a common interchange format such as some of the Unicode representations that are often used in XML or Java must first be translated into other formats that the system can operate on natively and then converted back to that common interchange format for storage or to send to another application for use. These data blocks are processed by the execution unit in the microprocessor. The data is thus brought in as operand data into the local data cache. Since the size of these data blocks in the common interchange formats are often much larger than the size of entire local data cache the entire current contents of the local cache is replaced as a result of the operation using normal cache replacement schemes. It is often that in these cases of data translation the programming thread that has the task of translating the data is not the same thread that will operate on the translated data. When the system has many processors in it the thread that translates it and the thread that will use the translated results may in fact not run on the same processor in the system. As a result the entire local data cache has been written with data that no other local thread will use and thus have polluted the local cache with this common interchange format data and lost the data that was in the local cache and that did have locality.

### SUMMARY OF THE INVENTION

In existing computer systems with a microprocessor that contains one or more execution units with local cache memory when data is brought into the cache memory to be executed on it gets installed into the local cache memory. There are several possible schemes by which it can be installed, however they all in some way expect that data to be used referenced one or more times right after it is installed. There is a class of application models and data types that require that in order for the execution units to operate on or manipulate the common interchange data it must be first converted to a format that the execution elements can act on. In the programming model that acts on this data the programming thread that converts or manipulates the data is not the same thread that will act on converted data. In a system with many processors these threads may be executed on different processors.

Our invention is that when certain processor architecture instructions are decoded that are used to perform such conversions are executed that the operand fetch logic can signal to the local cache memory when the request for the data stored in memory is made it can indicate that it is a special type of request. In this case the data can be installed in the local cache that has more than one set with a different use scheme such that when requests are made for many lines of data that would install in the same congruence class in the cache they will be installed over top of each other rather than filling all the congruence classes in the cache with this data. This will preserve the data that exists in those other congruence classes. One such scheme change would be to install the data without modification of the least recently used tag. In this way the least recently used line will be selected for this data and when the next line of this data is fetched that falls in the same congruence class it will also be written into this same position. In this way data that will only be referenced once in the process of conversion of the data will all only fill one congruence class in the local cache with more than one set associativity and not remove other data that will still have locality when the data conversion finishes execution. This further can be used for an instruction that executes for which the data that it references will only ever be used once. This can be done on an operand by operand basis on an instruction by instruction basis. Thus only data that will be referenced once and have no locality beyond that one single reference will not be allowed to pollute all the local cache memory.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which allows execution of instructions that reference data operands that exceed the size of the local cache without polluting all of the local cache with data that has no locality.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of program data located in the main memory address map.

FIG. 2 illustrates an example of some of the design blocks in a computer system.

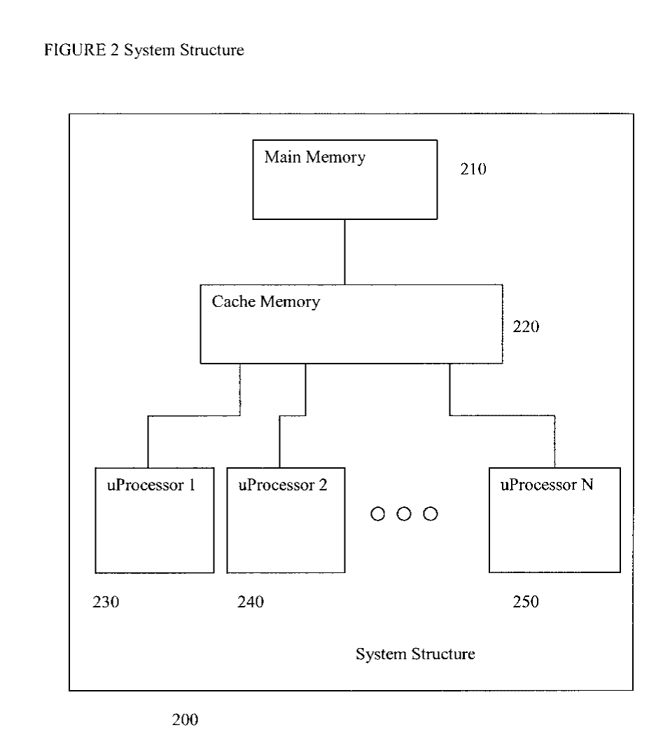

FIG. 3 illustrates an example of some of the design blocks in a microprocessor.

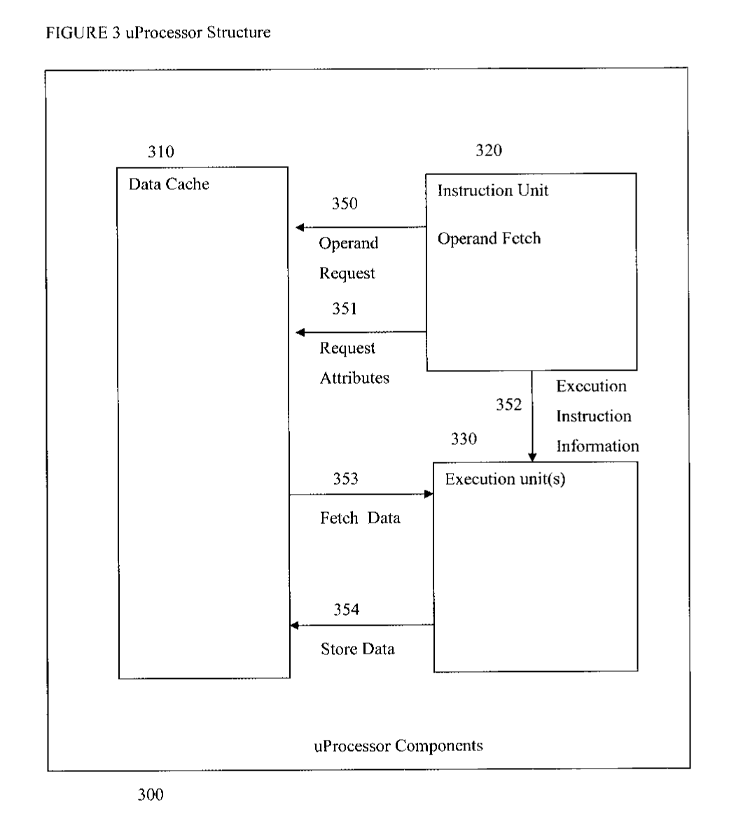

FIG. 4 illustrates an example of some of the design blocks in the data cache unit.

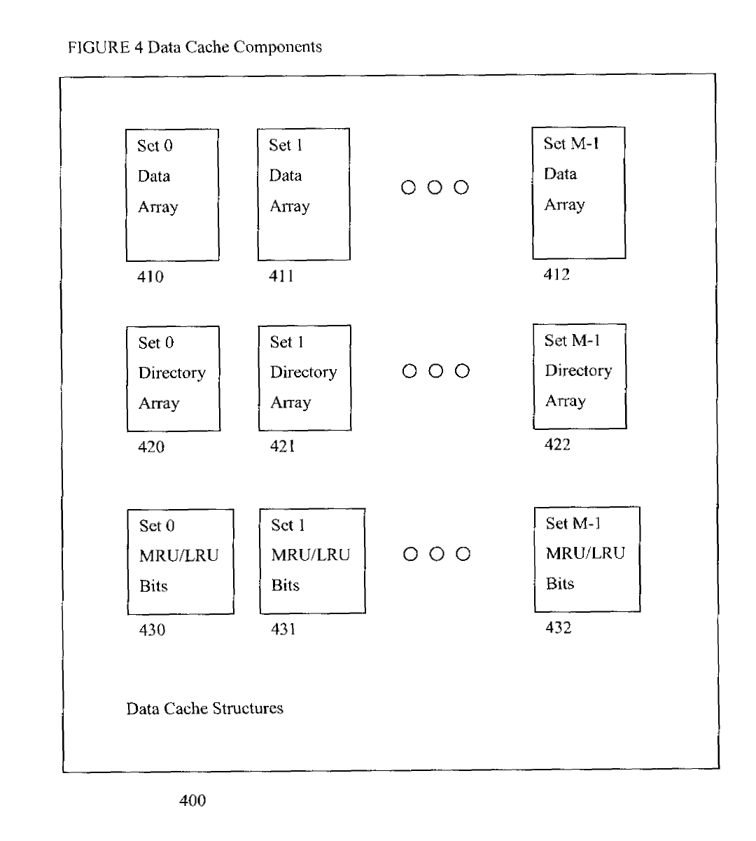

FIG. 5 illustrates an example of some of the design blocks in the instruction unit.

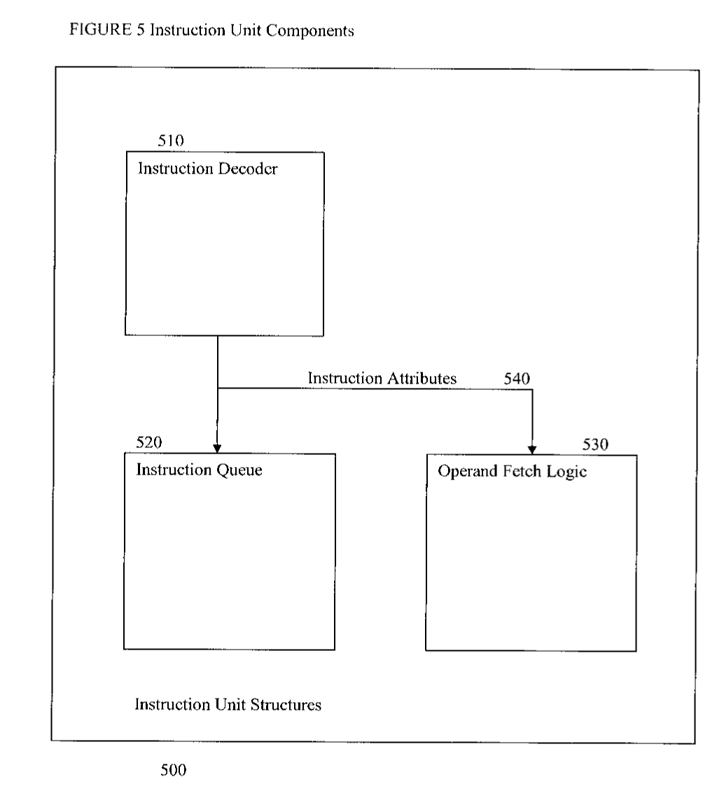

The detailed description explains the preferred embodiments of the invention, together with advantages and features, by way of example with reference to the drawings.

### DETAILED DESCRIPTION OF THE INVENTION

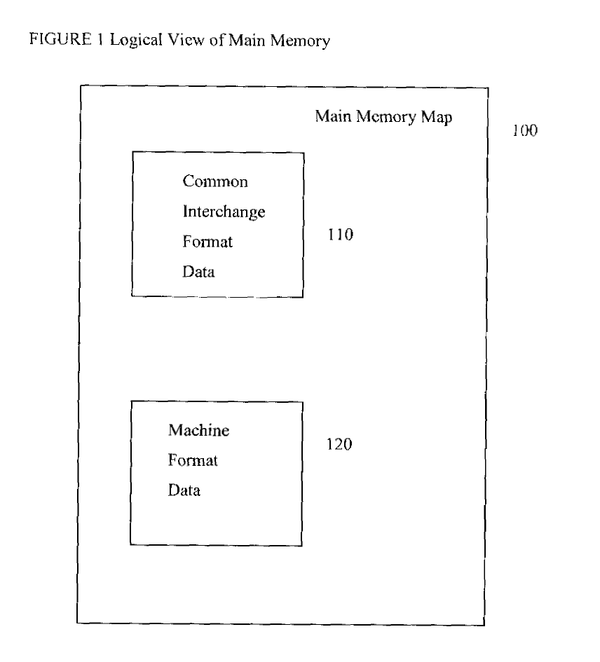

In the current computing environment it is very common for the data to be kept in a data format that is portable between different software and different hardware platforms. It is often kept in some industry standard format. This format is not the format that the machine is designed to operate on natively. In FIG. 1 we sec the main memory map, 100, for a computer system. The data that arrives in the common interchange format it gets assigned a location in storage, 110. Before any actions or alterations can be made to the data it must first be converted to the local machine data format which gets another location in storage, 120. The application code that will act on or alter the data will first have to convert from the common interchange format to the local machine format. When that application is multithreaded and you have a computer system with multiple processors it is not know which thread will execute on which microprocessor in the system. It is often that one thread will convert from the common interchange format to local machine format. Other threads will act on or alter the data, and yet a different thread will convert the local machine format back to the common interchange format before it can be sent to any other system or application for action. It is also often that the size of these data operands in both the common interchange format and the local machine format is very large in comparison to the local cache sizes in the microprocessors.

In a multiprocessor computer system, 200, there is a main memory, 210, where the data in both the common interchange format and the local machine format will reside. These data objects will be brought into and out of the local cache on each microprocessor, 230, 240, and 250. In our system there is a layer of shared cache, 220. It is often the case that more than one thread or processor may wish to access this operand data, and thus a benefit if the data is held in the common cache structure.

In the microprocessor, 300, there are many components. In particular there is a data cache, 310, an instruction unit, 320, and execution unit(s), 330. When the instruction unit decodes instructions it makes operand requests, 350, to the data cache. These operand requests, 350, have attribute information, 351, that data the data cache, 300, about the request type and other information about the request. It also forwards information on to the execution unit(s), 330, on the instruction execution information link, 352. When the operand was a fetch request data flows from the data cache, 310, to the execution unit(s), 330, via the data fetch bus, 353. When the operand request was a store the execution unit(s), 330, sends the updated data on the store data bus, 354.

Inside the data cache, 400, there are multiple elements. In this case the data cache has a set associativity of M where M is greater than 1. In this cache there are data arrays, 410, 411, and 412 where the data for each set is stored. There are directory arrays, 420, 421, and 422 that indicate what data is present in the arrays. In order to determine a line replacement target for when new data is brought into the cache there MRU (most recently used)/LRU (least recently used) bits for each set, 430, 431, and 432, that are kept for each set and that are updated based on access patterns and original installation values.

Inside the Instruction unit, 500, there are several blocks. There is the instruction decode unit, 510, which determines the characteristics of the instruction that is decoded and send those characteristics, 540, to the instruction queue, 520, and the operand fetch logic, 530. The instruction queue, 520, will forward information about the instruction to execute to the execution units(s), 330. The operand fetch logic, 530, will use this information to send operand requests, 350, and request attributes, 351, to the data cache, 310.

In our invention the instruction decode unit, 510, recognizes when the instruction that is about to execute is an instruction from an application thread that is designed to convert the common interchange format to a local machine format or local machine format to common interchange format. It informs the operand fetch logic, 530, of this fact. When the operand fetch logic, 530, sends the operand request, 350, to the data cache, 310, it will also for this operand set a bit in the attribute information, 351, that indicates to modify the MRU/LRU information. Then inside the data cache, 400, the bit that was sent with the operand request, 350, in the attribute information, 351, that said to modify the MRU/LRU information will alter how the MRU/LRU bits are set in 430, 431, or 432 when either the common interchange format data or the local machine is first installed in the cache. This is done such that when these very large data operands which are larger than the size of the microprocessor data cache are brought into the data cache they will be installed over and over again into the same set and not into multiple sets. In this way that data that will be converted will installed in the same given set as each line that hits the same congruence class s installed in the data cache. This allows data that will be used when the conversion completes to remain active in the cache.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable application program code for providing and facilitating the capabilities of the present invention. The application code may be an article of manufacture which can be included as a part of a computer system or sold separately.

The diagrams depicted herein are just examples. There may be many variations to these diagrams or the steps (or operations) described therein without departing from the spirit of the invention. For instance, the steps may be performed in a differing order, or steps may be added, deleted or modified so long as the claimed result is accomplished. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer system having multiple microprocessors, comprising:
a plurality of microprocessors for said computer system utilizing a common interchange format;
a first microprocessor of said microprocessors having with a local data cache with more than one set of congruence classes; and
an instruction decoder that decodes a given instruction to be executed and as a result knows attributes about operands to be accessed for said instruction;
said first microprocessor having a local data cache with a plurality of cache lines that has most recently used (MRU) bits or least recently used (LRU) bits stored therein enabling knowing which cache line to select for replacement;
and wherein an attribute bit on a request made to the data cache can alter normal values set in the MRU or LRU bits when a new cache line is installed in said local data cache so that all operand data for said given instruction's operand will be installed in a single data set.

2. The system of claim 1 wherein a given instruction that is executing may be allowed by said architecture to have a very long operand length equaling the size of a cache line or larger.

3. The system of claim 1 wherein a computer architecture for said system provides a local machine format for at least said first microprocessors that is different from that of said common interchange format.

4. The system of claim 4 wherein application code with multiple execution threads that requires that the application data needs to be converted from said common interchange format to a local machine format in order to operate on is provided.

5. The system according to claim 4 wherein said application data is processed by said application code such that the application data will be brought into the microprocessor data cache such that only one set is written in the local data cache with the application data.

6. The system of claim 4 wherein application code with multiple execution threads that requires that the application data needs to be altered and converted back to said common interchange format from a local machine format in order to operate on is provided.

7. The system according to claim 6 wherein said application data is processed by said application code such that the application data will be brought into the microprocessor data cache such that only one set is written in the local data cache with the application data.

8. A computer system, comprising:
a plurality of microprocessors,
a computer architecture for said microprocessors permitting instructions that will need to access data into the local data cache but providing that that application data will have no locality in execution;
at least one microprocessor of said plurality of microprocessors with a local data cache with more than one set of congruence classes;
an instruction decoder that can as a result of decode of a given instruction to execute know attributes about the operands to be accessed for said given instruction;
a microprocessor local data cache coupled for access by said one microprocessor that has most recently used (MRU) bits or least recently used (LRU) bits indicating which cache line of said local data cache to select for replacement;
and wherein an attribute bit on a request made to the local data cache that can alter the normal values set in the MRU or LRU bits when a new cache line is installed in the local data cache so that all operand data for this given instruction's operand will be installed in a single data set.

9. The system according to claim 8 wherein said one microprocessor has its local data cache provided with multiple sets of congruence classes that can alter how new cache data for a given instruction operand is installed in the cache such that only one set of the local data cache will be written with operand data for that instruction.

10. The system according to claim 8 wherein multiple microprocessors of said computer system have a local data cache with multiple sets of congruence classes that can alter how new cache data for a given instruction operand is installed in the cache such that only one set of the local data cache will be written with operand data for that instruction.

11. The system of claim 10 wherein a given instruction that is executing may be allowed to have a very long operand length such as the size of a cache line or larger.

12. A method for preventing operand from polluting a data cache in a computer system, comprising
providing said computer system with a computer architecture for multiple microprocessors where a local machine format is different than that of a common interchange format,
setting a local machine format different than that of the common interchange format in a microprocessor with a local data cache with more than one set of congruence classes and that has most recently used (MRU) bits or least recently used (LRU) bits to know which cache line to select for replacement;
decoding a given instruction for said microprocessor with an instruction decoder that can as a result of decode of an instruction to be executed by said microprocessor know attributes about the operands to be accessed;
and decoding an attribute bit on the request made to the data cache that can alter the normal values set in the MRU or LRU bits when a new cache line is installed in the local data cache so that all operand data for this given instruction's operand will be installed in a single set.

13. The method according to claim 12 including executing application code with multiple execution threads that requires that application data for said application code needs to be converted from a common interchange format to a local machine format in order to operate

14. The method according to claim 12 including executing application code with multiple execution threads that requires that application data for said application code needs to be altered and converted back to that common interchange format such that the application data will be brought into the microprocessor data cache in such a way that only one set in the local data cache will be written with the application data to be converted.

15. The method of claim 1 wherein the instruction that is executing may be allowed to have a very long operand length such as the size of a cache line or larger.

16. A computer system, comprising a plurality of microprocessors, a cache memory for said processors, and a main memory coupled to said cache memory for providing a data cache, application code having instructions to be decoded and processed,
means to identify based on a given instruction being decoded that the operand data which the given instruction will access by its nature will not have locality of access and should be installed in said cache in such a way that each successive line brought into the data cache that hits the same congruence class should be placed in the same data set as to not disturb the locality of the data that resided in the data cache prior to the execution of the given instruction that accessed the data that will not have locality of access.

17. The computer system according to claim 16 wherein an attribute bit on a request made to the data cache identifies that the system can alter the normal values set in the a most recently used (MRU) bits or least recently used (LRU) bits when a new cache line is installed in the local data cache so that all operand data for this given instruction's operand will be installed in a single set.

18. The computer system of claim 17 wherein the instruction has a very long operand length equaling the size of a cache line or larger.

19. A method of A method for preventing operand from polluting a data cache in a computer system, comprising
providing said computer system with a computer architecture for multiple microprocessors where a local machine format is different than that of a common interchange format,
setting a local machine format different than that of the common interchange format in a microprocessor with a local data cache with more than one set of congruence classes and that has most recently used (MRU) bits or least recently used (LRU) bits to know which cache line to select for replacement;
identifying based on a given instruction being decoded that the operand data which the given instruction will access by its nature will not have locality of access and should be installed in said cache in such a way that each successive line brought into the data cache that hits the same congruence class should be placed in the same data set as to not disturb the locality of the data that resided in the data cache prior to the execution of the given instruction that accessed the data that will not have locality of access.

20. The method according to claim 19 wherein an attribute bit on a request made to the data cache identifies that the system can alter the normal values set in the a most recently used (MRU) bits or least recently used (LRU) bits when a new cache line is installed in the local data cache so that all operand data for this given instruction's operand will be installed in a single set.
